(19) United States
(12) Patent Application Publication
(10) Pub. No.: US 2018/0278500 A1
(43) Pub. Date: Sep. 27, 2018

(54) SCALABLE STREAMING ANALYTICS PLATFORM FOR NETWORK MONITORING

(71) Applicant: The Trustees of Princeton University, Princeton, NY (US)

(72) Inventors: Nick Feamster, Princeton, NJ (US); Arpit Gupta, Princeton, NJ (US); Walter Willinger, Madison, NY (US)

(21) Appl. No.: 15/933,598

(22) Filed: Mar. 23, 2018

Related U.S. Application Data
(60) Provisional application No. 62/476,298, filed on Mar. 24, 2017.

(51) Int. Cl. H04L 12/26; G06F 17/30; H04L 29/06

(52) U.S. Cl. CPC H04L 43/06; G06F 17/30516; H04L 63/1425; G06F 17/30864

(57) ABSTRACT

The disclosed systems and methods can provide a closed-loop system that enables network operators to perform streaming analytics for network monitoring applications at scale. The disclosed systems and methods can allow operators to express network monitoring queries as operations over tuples, and can allow them to partition the queries across both switches and a stream processor, and, through iterative refinement, attempt to extract only the traffic that pertains to the query, thus ensuring that the stream processor can scale to satisfy a large number of queries for traffic at very high rates. According to an example method, network monitoring queries are partitioned between components in a network and iteratively refined based on output of the network monitoring query. The network components can include a data plane component (e.g., a switch) and a stream processor component. The network monitoring queries can be refined based on output from the stream processor component.

### RELATED APPLICATION

This application claims the benefit of U.S. Provisional Application No. 62/476,298, filed on Mar. 24, 2017. The entire teachings of the above application(s) are incorporated herein by reference.

### GOVERNMENT SUPPORT

This invention was made with government support under Grant #CNS-1539920 awarded by the National Science Foundation. The government has certain rights in the invention.

### BACKGROUND

To ensure that a network is secure and performs well in the face of continually changing network conditions (e.g., failures, attacks, and shifts in traffic load), operators need to collect and fuse heterogeneous streams of information from traffic statistics to alerts from intrusion detection systems and other monitoring devices. Operators currently collect these data streams, which often arrive at high data rates. Yet, despite the fact that these streams contain rich information about the security and performance of the network, operators have difficulty analyzing the information.

### SUMMARY

The disclosed systems and methods can provide a closed-loop system that enables network operators (e.g., human operators, such as network operators, security analysts, IT specialists, and non-human operators, such as expert systems and AI engines) to perform streaming analytics for network monitoring applications at scale. The disclosed systems and methods can allow operators to express network monitoring queries as operations over tuples, and can allow them to partition the queries across switches and a stream processor, for example, and, through iterative refinement, attempt to extract only the traffic that pertains to the queries, thus ensuring that the stream processor can scale to satisfy a large number of queries for traffic at very high rates.

One example embodiment is a system for performing streaming analytics. The example system includes a runtime module, a data plane component, and a stream processor. The runtime module is configured to partition network monitoring queries between the data plane component and the stream processor. The runtime module can be further configured to iteratively refine the network monitoring queries based on output of the network monitoring queries. Alternatively, the runtime module can be configured to iteratively refine network monitoring queries processed by at least one of the data plane component and the stream processor, the runtime module iteratively refining the network monitoring queries based on output of the network monitoring queries.

Another example embodiment is a method of performing streaming analytics. The example method includes partitioning network monitoring queries between components in a network, and iteratively refining the network monitoring queries based on output of the network monitoring query.

Another example embodiment is a machine readable storage medium having stored thereon a computer program for performing streaming analytics. The computer program comprising a routine of set instructions for causing the machine to partition network monitoring queries between components in a network, and iteratively refine the network monitoring queries based on output of the network monitoring query.

In many embodiments, the stream processor passes the output of the network monitoring queries to the runtime module for iterative refinement. In many embodiments, the data processing component is a switch.

The systems and methods can further include a query engine configured to enable the network monitoring queries to be expressed as operations over a stream of tuples. The network monitoring queries can specify whether a given operation is to be processed by the data plane component or by the stream processor component.

In some embodiments, the data plane component can include a fabric manager configured to receive high-level configurations from the runtime module and compile the high-level configurations into platform-specific device configurations. The data plane component can process incoming data packets based on the configurations received from the runtime module.

In some embodiments, the stream processor can include a streaming manager configured to receive high-level configurations from the runtime module and compile the high-level configurations into platform-specific streaming data processing pipelines. The stream processor can be configured to receive data from the data plane component and execute a data processing pipeline over received packets processed as tuples based on the configurations received from the runtime module.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic diagram illustrating a system for performing streaming analytics, according to an example embodiment.

FIG. 2 is a schematic diagram illustrating a method of performing streaming analytics, according to an example embodiment.

FIG. 3 is a schematic diagram illustrating a method of performing streaming analytics, according to an example embodiment.

FIG. 4 is a schematic diagram illustrating a system for performing streaming analytics, according to an example embodiment.

FIG. 5 illustrates a computer network or similar digital processing environment in which embodiments of the present invention may be implemented.

FIG. 6 is a diagram of an example internal structure of a computer in the computer system of FIG. 5.

### DETAILED DESCRIPTION

A description of example embodiments follows.

Network traffic monitoring has traditionally been a case of extremes, and a confluence of recent paradigm shifts in network measurement has brought this “either feast or famine” dichotomy more sharply into focus. For example, when collecting IP Flow Information eXport (IPFIX) records, the number of flows that traverse large backbone networks, Internet exchange points (IXP), or interconnects creates serious challenges. With traffic rates in the Gbps to Tbps ranges, the velocity of the data is such that any attempt to develop (close to) real-time solutions must treat the measurements as streaming data, where only a single pass over the data is affordable. Finally, this streaming data is distributed, since traffic monitoring “sensors” (i.e., the routers, switches, and middleboxes that gather statistics) are dispersed across the network. Such distributed streaming data is representative of recent “big data” occurrences in different application domains.

If one considers the existing state of the art as an example—specifically, the reliance on IPFIX (e.g., NetFlow) traffic flow records—the resulting distributed streaming data presents both too much and too little data to perform meaningful traffic analysis. In one sense, this approach can present too much data: Existing state-of-the-art systems such as Deepfield Defender, rely on a centralized data repository where all data can be stored and analyzed using a single analysis system. These types of centralized solutions are quickly becoming obsolete, because shipping all data to one location is not only prohibitively expensive but also introduces delay that is too large for many real-time analysis and detection problems. Even if it were possible to store and analyze all of these data in a central location, the coarse granularity of the data—specifically, the lack of payloads, timing information, headers, and other information which are often critical for security applications or performance diagnosis—means that the existing datasets are often too little to be useful for many operational tasks.

With the disclosed approach, network traffic monitoring systems can aim to provide “just the right” data for the task at hand, and it is observed that the network traffic that is “relevant” or “interesting” for any particular task (e.g., performance analysis, intrusion detection) is the result of queries that concern only a minuscule portion of the overall traffic. For example, in the case of user-perceived performance problems with an individual video streaming service, the “interesting” data consists of all flows associated with this service and its users. Similarly, when trying to detect DNS-based amplification attacks, the “relevant” data is contained in the DNS portion of the overall traffic.

Programmable switches potentially make it easier to perform flexible network monitoring queries at line rate, and scalable stream processors can make it possible to fuse data streams to answer more sophisticated queries about the network in real-time. However, processing such network monitoring queries at high traffic rates requires that both the switches and the stream processors filter the traffic iteratively and adaptively so as to extract only that traffic that is of interest to the query at hand. An example of the disclosed approach is a new platform that allows network operators to make the best use of state-of-art programmable devices and stream processors when executing real-time or batched high-level network analytics queries.

Disclosed herein are example designs and implementations of a closed-loop system that enables network operators to perform streaming analytics for network monitoring applications at scale. To achieve this objective, the disclosed systems and methods can allow operators to express network monitoring queries by considering each packet as a tuple, and can partition queries across switches and a stream processor. Through iterative refinement, a runtime module can attempt to extract only the traffic that pertains to the query, thus ensuring that the stream processor can scale to satisfy a large number of queries for traffic at very high rates.

The disclosed approach can be used to express and execute any kind of real-time as well as batched network analytics queries in a scalable manner. It can be used to express queries related to network management (e.g., performance, security), Quality-of-Experience (QoE), and other areas that can benefit from making decisions in a data-driven manner. It can be used by network personnel, including operators running enterprise networks, data centers, wide area networks, and/or peering infrastructure (Internet exchange points) etc.; IT personnel including network security analysts; marketing and sales personnel; etc.

An example implementation of the disclosed approach can include four example components:

1. Query Engine: This component provides a means for network operators to express the queries related to their applications. An application can either be a single query or include multiple queries (e.g., conditionally fusing different data streams). This interface is meant to hide all of the details of iterative refinement and query partitioning from the programmer. It can be designed to run queries related to multiple applications simultaneously.

2. Runtime: This component takes queries and produces query refinement and partitioning plans based on models that have been learned from training data. As part of the query partitioning process, it can generate packet processing rules for the data plane and data processing pipelines for the stream processor.

3. Fabric Manager: This component can run locally on each data plane device. It receives high-level configuration updates from the runtime and then compiles them into low-level platform-specific device configurations.

4. Streaming Manager: This component can run locally on each stream processor in the network. It receives high-level configurations from the runtime and compiles them into platform-specific streaming data processing pipelines.

The disclosed approach can leverage two components to execute an operator's high-level network analytics query: (1) a programmable data plane, which processes incoming data packets and takes actions according to rules that the runtime has installed, which may include forwarding traffic to the stream processor, and (2) a stream processor, which receives data from the switches and executes the data processing pipeline over the incoming packets, which are processed as tuples. To facilitate iterative refinement, the stream processor can send the query to the runtime after each time interval.

While the programmable data plane and stream processor can each process a portion of a query, it should be appreciated that all of the queries could be executed by either the data plane or the stream processor alone, or any combination between the two components. For example, with data plane technology available today, about 50% of a typical query can be executed at line rate in the data plane; but in legacy networks, all queries might have to be processed at the stream processor. For technologies developed in the future, the percentage could move closer to 100% (i.e., the whole query might be able to be executed at line rate in the data plane). It should also be appreciated that while a switch device is used herein to describe an example programmable data plane, the data plane can be implemented using other types of components, including, for example, a programmable Network Interface Card (NIC), Raspberry Pi processor, or software switch.

Example features of the disclosed approach include: (1) It can provide a query interface where users can express their high-level network analytics query in a logically centralized manner. The network operator can express her queries without having to worry about where and how the queries are executed. (2) It can iteratively refine the input query to scale the resource requirements. Using iterative refinement, it can first execute the query at coarser level of refinement (requiring fewer resources) and then iteratively zoom-in, spending more resources on portions of the traffic that is deemed interesting by the original input query. (3) It can partition the data processing pipeline for each query between horizontally scalable stream processors and programmable data plane (P4-based, OF-based etc.). (4) It can leverage (deep) machine learning on training data to automatically learn the optimal plan for the iterative refinement process (i.e., refinement plan) for each input query and the best plan for partitioning each input query. (5) It can run on a single node as well as in a distributed environment consisting of multiple nodes and with a central command and control node. (6) If used as a query engine for real-time detection of network performance or security problems, it can be integrated directly with real-time mitigation capabilities.

Example benefits of the disclosed approach include: (1) It can provide a simple interface for network operators to express their network analytics queries, and (2) it can scale the execution of complex analytics queries by exploiting available information in intelligent ways to iteratively refine and partition the input query, making better use of limited available resources.

The following is a more detailed description of the disclosed systems and methods.

To ensure that a network is secure and performs well in the face of continually changing network conditions (e.g., failures, attacks, and shifts in traffic load), operators need to collect and fuse heterogeneous streams of information from traffic statistics to alerts from intrusion detection systems and other monitoring devices. Operators currently collect these data streams, which often arrive at high data rates. Yet, despite the fact that these streams contain rich information about the security and performance of the network, operators have difficulty analyzing the information.

Several factors make it difficult for network operators to analyze network traffic statistics to perform even basic analysis concerning the operation of a network. First, existing hardware offers relatively fixed-function measurement capabilities (e.g., IP Flow Information eXport (IPFIX) and Simple Network Management Protocol (SNMP)), and enabling these functions is often a costly all-or-nothing decision. Second, because operators have no way of specifying what types of data they are interested in before it is collected, the configuration of these capabilities is often static (e.g., a fixed sampling rate for IPFIX records), resulting in data that is either too high volume to store or process, or too coarse to be particularly useful in answering questions of interest. Finally, existing approaches have no meaningful way to fuse these data streams, even though it is often the correlation of signals from multiple streams that can lend insight into higher-level performance or security problems.

Advances in both programmable switch hardware and streaming data analysis platforms make it possible to address these challenges. Improved switch programmability and better data stream processing capabilities can improve the utility of network measurement. Programmable switches such as OpenFlow switches make it possible to capture subsets of traffic by inserting rules in the switches that rely on simple match criteria in packet headers; software controllers update these rules and make it possible to update these rules in real-time, creating the potential for closed-loop feedback, where current observations can drive future decisions about which traffic to capture. In addition to better switch capabilities that allow for the collection of richer data streams, new system capabilities can make it easier to process and analyze network data: Streaming data processing platforms such as Spark Streaming and Apache Storm make it possible to efficiently process queries on streams of tuples at relatively high data rates, and to issue queries based on combinations of heterogeneous data streams, facilitating complex queries that combine heterogeneous data sources, possibly from multiple distinct network vantage points.

Performing streaming data analysis on existing network traffic streams is more challenging than simply pointing existing streams from switches at off-the-shelf stream-processing systems. One challenge is the quantity of data: Considering the volume of traffic traversing a backbone network or switch at a large Internet exchange point, it is clear that the volume of data is far too high for a typical stream processing system—although these systems are designed to “scale out” as data rates increase, traffic rates are high, already at several terabits per second, and increasing quickly; and processing data at increasingly high rates raises both cost and complexity. Previous work, such as OpenSoc, describes the complexity of processing millions of packets per second, which is still several orders of magnitude less than what exists in large backbone networks and Internet exchange points. Instead, disclosed herein are systems and methods that can use knowledge of the operator's query to refine the data that each switch collects, reducing the data that individual switches must export, but nonetheless allowing for refinements of the measurements later in the process.

Consider the example of detecting a DNS reflection attack, whereby an attacker sends many DNS queries with a source IP address that is spoofed to be that of the victim. In this case, the operator might detect the attack by noticing a sudden increase in query volume or rate from a single source IP address, possibly for entirely new domains. Yet, even tracking this simple trend—the rate of DNS queries from individual source IP addresses—could in principle require creating a counter for each IP address, which is prohibitive, particularly given the increasing prevalence of IPv6. Instead, the operator might want to express a query that operates on smaller subsets of the total data and iteratively refines itself to “zoom in” on the attack traffic.

Disclosed herein are systems and methods (referred to herein as “Sonata”) that allow an operator to express these types of queries using widely accepted programming idioms in distributed data analytics. Specifically, Sonata allows a network operator to view each packet as a tuple and express queries as operations over tuple streams, just as in other data stream processing systems. A tuple is a finite ordered list (sequence) of elements. The Sonata runtime can then both: (1) partition the workload between the switches and the stream processing system to ensure that the stream processor does not become overloaded, and (2) iteratively refine the configurations for the data plane and the stream processor to allow operators to inspect traffic at finer granularities when anomalies or other interesting scenarios arise. Existing streaming analytics platforms for network monitoring view the data stream as exogenously given. In contrast, Sonata can consider the data to be endogenously determined; i.e., it relies critically on a built-in feedback mechanism between the stream processor and the programmable data plane to adaptively refine the data stream itself, thus reducing the load on stream processors and enabling them to process queries for traffic streams at very high rates. It is in this sense that network monitoring can be viewed as a new type of streaming analytics problem.

Described herein is an evaluation of the disclosed systems and methods in the context of DNS reflection attack detection and showing that it is possible to “zoom-in” on traffic of interest while capturing far less traffic that does not pertain to the attack itself. A simple example query involving DNS reflection attacks is used to show that Sonata can capture 95% of all traffic pertaining to the query, while reducing the overall data rate by a factor of about 400 and the number of required counters by four orders of magnitude.

Prior Approaches

One example of the spectrum of design options for Sonata is to execute monitoring queries entirely in user space. Sonata solves what a long line of related efforts in the database community has not been able to solve. Chimera (K. Borders, J. Springer, and M. Burnside. Chimera: A Declarative Language for Streaming Network Traffic Analysis. In Proceedings of the 21st USENIX Conference on Security Symposium, pages 365-379. USENIX, 2012) introduced a new query language based on a streaming SQL for processing network traffic in user-space. Network operators have leveraged the recent advances in the area of scalable streaming data analysis to build platforms capable of processing network data at very high rates. The database community has also explored the query optimization problem extensively. Gigascope (C. Cranor, T. Johnson, O. Spataschek, and V. Shkapenyuk. Gigascope: A Stream Database for Network Applications. In Proceedings of the 2003 ACM SIGMOD International Conference on Management of Data, pages 647-651. ACM, 2003) uses query partitioning to minimize the data transfer within the stream processor. Geodistributed analytics systems such as Clarinet (R. Viswanathan, G. Ananthanarayanan, and A. Akella. Clarinet: WAN-Aware Optimization for Analytics Queries. In OSDI, 2016) use forms of query partitioning. Yet, executing all transformations in the user space is costly. As a result, these platforms face major scalability challenges at high data rates.

Another example of the design spectrum for Sonata is to execute the monitoring queries entirely in the data plane. Executing monitoring queries in the data plane is not new. Before the days of programmable data planes, vertically integrated monitoring programs with limited (and fixed) functionalities like NetFlow, SFlow, IPFIX, and SNMP could execute simple monitoring queries. The advent of programmable data plane broadened the scope of monitoring queries that can be executed in the data plane.

OpenSketch (M. Yu, L. Jose, and R. Miao. Software Defined Traffic Measurement with OpenSketch. In 10th USENIX Symposium on Networked Systems Design and Implementation (NSDI 13), pages 29-42, 2013) equips switches with a library of predefined functions (e.g., count-min sketch, reversible sketch) in hardware; the controller selects and assembles them for different measurement tasks. UnivMon (Z. Liu, G. Vorsanger, V. Braverman, and V. Sekar. Enabling a RISC Approach for Software-Defined Monitoring using Universal Streaming. In Proceedings of the 14th ACM Workshop on Hot Topics in Networks, page 21. ACM, 2015) takes a “RISC-type” approach to measurement, replacing the entire library of predefined functions with a generic monitoring primitive on the routers in the form of a single universal sketch. Similarly, Narayana et al. (S. Narayana, A. Sivaraman, V. Nathan, M. Alizadeh, D. Walker, J. Rexford, V. Jeyakumar, and C. Kim. Co-designing software and hardware for declarative network performance management. In HotNets, 2016) proposed the design of a switch supporting a range of network performance queries that execute on the switch using a programmable key-value store. The queries enabled by the programmable data plane are not suited for applications that (1) require joining multiple data streams; (2) require executing more complex operations such as skyline monitoring, or frequent, rare, or persistent itemset mining; and (3) require processing packet payloads, e.g., monitoring applications described in Chimera.

ProgME (L. Yuan, C.-N. Chuah, and P. Mohapatra. Progme: Towards programmable network measurement. SIGCOMM Comput. Commun. Rev., 37(4):97-108, August 2007) and Jose et al. (L. Jose, M. Yu, and J. Rexford. Online measurement of large traffic aggregates on commodity switches. In Proceedings of Hot-ICE′ 11. USENIX, 2011) also explored the idea of iterative refinement for detecting heavy hitter traffic. They use iterative refinement to minimize the number of counters required to identify hierarchical heavy hitters, but ProgME requires multiple passes over the same packets—making scalability to high data rates very challenging. Unlike Sonata, these systems concentrate on executing queries entirely in the data plane. However, as described herein, the combined use of a general purpose stream processor and the programmable data plane can give network operators the “best bang for the buck”—the flexibility of stream processing and the speed of the data plane.

Example Applications of the Disclosed Systems and Methods

The following describes how three network monitoring problems—reflection attack monitoring, application performance analysis, and port scan detection—can be expressed as streaming analytics problems.

Reflection attack monitoring—Consider the problem of detecting DNS amplification attacks, where compromised machines send spoofed DNS requests to resolvers. These spoofed requests have source IP addresses inside the target network. One such reflection attack on Spamhaus in 2013 used some 30,000 open resolvers around the globe and an amplification factor of about 70 to generate attack traffic with an intensity of around 75 Gbps.

A straightforward approach to detect DNS-based amplification attacks in real-time requires maintaining state for every unique IP address and keeping track of the difference between the observed DNS requests and responses for each IP address; if that difference exceeds a pre-specified threshold, it may indicate the onset of an attack. At an Internet exchange point (IXP), every traffic flow that traverses the IXP switching fabric can be mapped to a source and destination MAC address corresponding to where the traffic enters and leaves the IXP switch. Traffic volumes at such a location are so high that they would overwhelm any reasonably-provisioned stream processor; yet, because the traffic of interest is only a small fraction of DNS traffic (which is, in turn, only a small fraction of all traffic), the stream processor can take advantage of data-plane programmability to iteratively push rules into the data plane that only return traffic that satisfies the query.

Real-time application performance analysis—Assume a network with asymmetric network paths, such that data and acknowledgments traverse different paths in the network. Suppose a network operator wishes to construct a distribution of round-trip latency (or other statistics, such as jitter or packet loss) for all video streaming flows. Each network location sees a stream of packets. A stream of packets can be represented as a stream of tuples, having attributes such as timestamp, source IP, source port, destination IP, destination port, and application type. One location in the network will have the tuples corresponding to data traffic, and another may see tuples corresponding to the ACKs.

To create a stream of tuples that includes round-trip times, the tuples must be joined at each of the two locations. A filter operation can select for streaming video traffic, and a reduce operation can perform the necessary subtraction and aggregation to compute the round-trip latency over time. Note that the operator can express the query simply as filtering and reduce operations that view the network traffic as a single large collection of tuples, even though traffic may be distributed across multiple locations. Queries might also aggregate these statistics at coarser levels of aggregation (e.g., AS, prefix, or user group), iteratively zooming-in on user groups for which the measured round-trip time exceeds a given threshold.

Distributed port scan detection—Suppose an operator wants to detect port scans that may be coming from distributed locations (and, hence, appear at a variety of network locations). Existing intrusion prevention system (IPS) devices often cannot process traffic at high rates, and they typically only operate at a single network location. Instead, a network operator might write a query that counts the number of distinct SYN packets that never have a corresponding ACK packet, as in previous port scan detection work. By viewing each packet as a tuple, writing such a query is straightforward: a simple reduce operation can couple each SYN with a matching ACK, if it exists. Such a query must necessarily be distributed across the network, since SYNs and their corresponding ACKs may not traverse the same network devices.

Overview of the Disclosed Systems and Methods

The following provides an overview of an example implementation of Sonata and the design insights that allow it to scale to high data rates. Sonata allows network operators to specify monitoring queries and fuse data streams from multiple queries. Sonata may include a runtime module that compiles queries to generate a set of rules to install in the switches and processing pipelines at the stream processor.

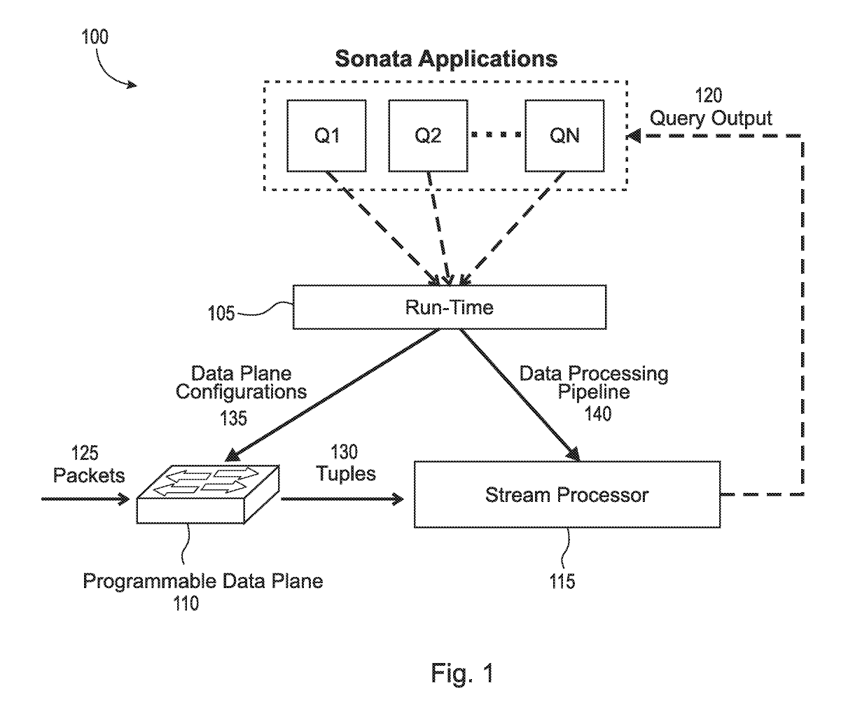

FIG. 1 is a schematic diagram illustrating a system 100 for performing streaming analytics, according to an example embodiment. The example system 100 includes a runtime module 105, a data plane component 110, and a stream processor 115. The runtime module 105 is configured to (i) partition network monitoring queries between the data plane component 110 and the stream processor 115 and (ii) iteratively refine the network monitoring queries based on output 120 of the network monitoring queries. FIG. 1 shows how the system can processes incoming network traffic 125 to extract tuples 130 that satisfy a particular query. Sonata's runtime 105 can translate each query into forwarding table entries 135 for a data plane 110 and data processing pipelines 140 for a stream processor 115. The data-plane operations can ensure that (1) filtering is based on relative sampling rates for different flows, and (2) the rate of the filtered data stream is always less than the system-defined constraints (e.g., span port capacity (P), and supported ingestion rate (R) for the streaming platform). Sonata may be implemented in Python, for example, and a Ryu controller can interact with software switches running Open vSwitch 2.5 and OpenFlow 1.3. The stream processor may be Apache Spark.

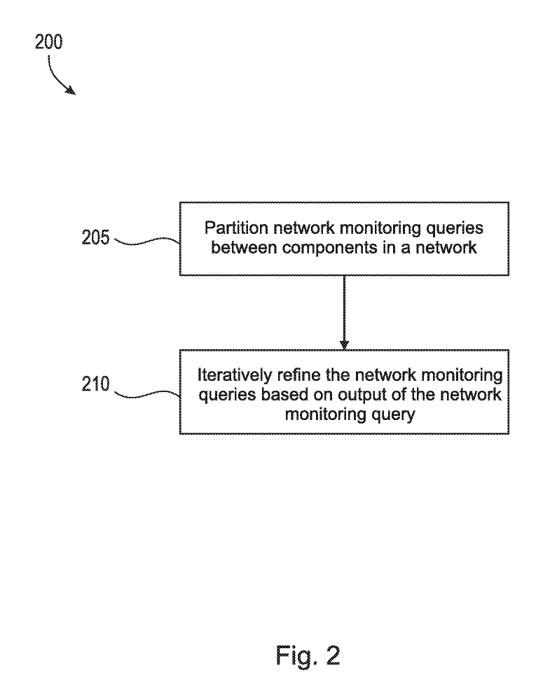

FIG. 2 is a schematic diagram illustrating a method 200 of performing streaming analytics, according to an example embodiment. The example method 200 includes partitioning 205 network monitoring queries between components in a network, and iteratively refining 210 the network monitoring queries based on output of the network monitoring query.

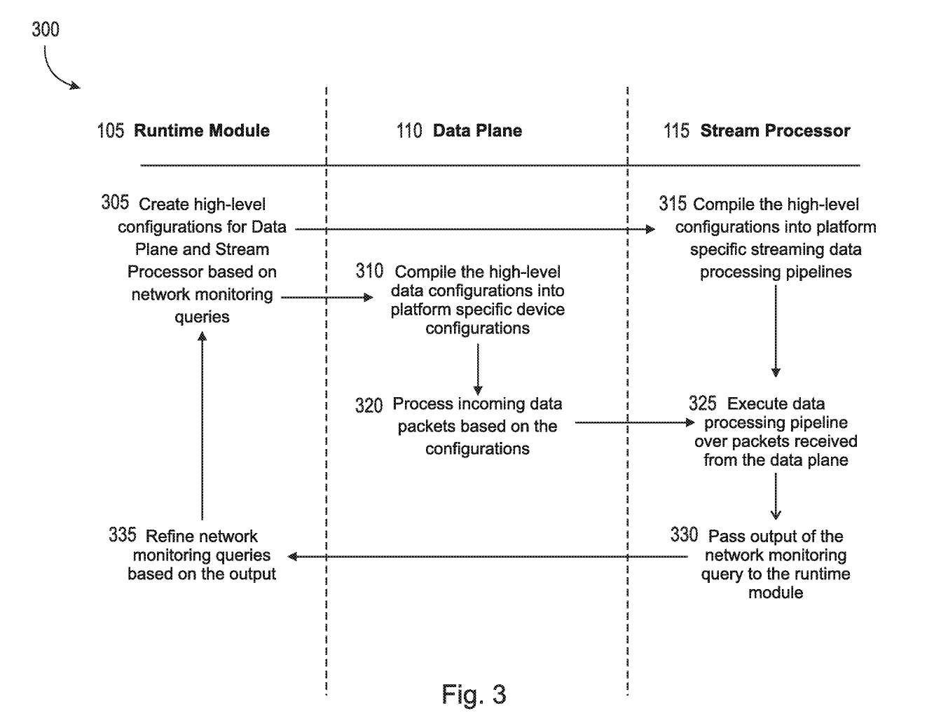

FIG. 3 is a schematic diagram illustrating a method 300 of performing streaming analytics, according to an example embodiment. FIG. 3 illustrates actions performed by a runtime module 105, a data plane component 110, and a stream processor 115 (illustrated in FIG. 1). According to the example method 300, the runtime module 105 creates 305 high-level configurations for the data plane 110 and the stream processor 115 based on network monitoring queries. The data plane 110 compiles 310 the high-level configurations into platform specific device configurations. The stream processor 115 compiles 315 the high-level configurations into platform specific streaming data processing pipelines. The data plane 110 process 320 incoming data packets based on the configurations, and the stream processor 115 execute 325 data processing pipeline over packets received from the data plane 110. The stream processor 115 passes 330 output of the network monitoring query to the runtime module 105, which refines 335 the network monitoring query(ies) based on the output. The method 300 can continue with step 305 in an iterative fashion.

The following provides a more detailed description of Sonata, using monitoring of DNS reflection attacks at a large IXP from as a running example: Simple detection of DNS reflection might count DNS request and response messages for each IP address at the IXP and compare the obtained values against a threshold at regular intervals to detect victim IP addresses. Although this particular example is used, other possible applications could include reflection attack monitoring for other UDP protocols, detection of distributed port scans, or monitoring TCP traffic across asymmetric paths to track the jitter of a video stream over time.

Packets-as-Tuples

Sonata can present network operators with the simple abstraction of packets as tuples, thus allowing them to write network monitoring queries in terms of operations over a stream of tuples, which is a common model for stream processing frameworks such as Apache Storm or Spark Streaming. The Sonata API can adopt and extend the functional API of Spark Streaming, for example, familiar to many programmers. Each packet header can be a tuple; the payload itself may also be represented as a tuple. Thus, each packet tuple can be a collection of field values including, for example, ts, locationID, sIP, sMac, sPort, dIP, dMac, dPort, bytes, payload, where locationID represents the location of the packet in the network (i.e., which switch it is traversing). The example below shows how a network operator might take a raw stream of packets, filter it according to some criterion (e.g., DNS replies), sample the resulting tuple stream at a given rate r, and count the resulting number of tuples within each time interval of length T. The argument to the filter operation can be a function literal (or lambda).

1 DNS=pktStream.filter(p=>p.sPort==53)

2 .sample(r).countByWindow(T)

Query Partitioning

Sonata can allow a programmer to specify whether a particular operation should execute in the data plane (operations denoted with the suffix D) or at the stream processor (used by default). For example, the “filterD” operation can apply filtering at the switch, whereas the “filter” operation applies it at the stream processor; a similar distinction applies for the “sampled”/“sample” operations. Programmers can specify this partitioning manually, but the process can also be automated. As an example, consider monitoring destination IPs (dIPs) for which the number of DNS replies over a time interval T exceeds a given threshold X. A programmer could specify that the switch should perform the initial filtering and sampling of the raw packet stream, reducing the workload on the stream processor:

1 IPs=pktStream

2 .filterD(p=>p.sPort==53)

3 .sampleD(r).map(p=>p.dIP)

4 .countByValueAndWindow(T)

5 .filter(t=>t.count>X)

Iterative Query Refinement

Sonata can allow network operators to express the logic for refining queries based on dynamic conditions, which may be referred to as iterative query refinement. Operators can use domain-specific insights to express their logic for refining queries.

As Sonata can enable combining multiple queries that fuse data streams, an interesting form of iterative query refinement occurs when the results from ongoing queries drive refinements to existing queries. For example, consider an application with two monitoring queries q₁ and q₂, each executing over a time interval of length T. Assume q₁ is parameterized by some argument A, i.e., q₁(A) and that a new value of A is produced by q₂ after every time interval, i.e., A(t+1)=q₂^{(t)}. Then, observe that q₂^{(t)} refines q₁ at time interval t+1: q₁^{(t+1)} (A(t+1))=q₁^{(t+1)} (q₂^{(t)}), since q₁ is affected by the execution of q₂ in the previous time interval.

The examples in earlier sections uniformly sample all the DNS response traffic, but at very high data rates; this approach may be prohibitive with a high sampling rate. Instead, one could sample the entire DNS response traffic at a lower sampling rate, and at a higher sampling rate only the traffic from “suspicious” IP addresses. The example below shows how an operator can specify this objective using iterative query refinement:

1 pvicIPs(t) =
2 pktStream.filterD(p => p.sPort == 53)
3 .sampleD(r0).map(p => (p.dIP, p.sIP))
4 .distinct.map(t => (t.dIP, 1))
5 .countByValueAndWindow(T)
6 .filter(t => t.count > X)
7
8 cvicIPs(t) =
9 pktStream.filterD(p => p.sPort == 53)
10 .filterD(p => p.dIP in pvicIPs(t−1))
11 .sampleD(r1).map(p => (p.dIP, p.sIP))
12 .distinct.map(t => (t.dIP, 1))
13 .countByValueAndWindow(T)
14 .filter(t => t.count > X′)

This example identifies confirmed victim IP addresses (i.e., cvicIPs) by combining two queries executed over successive time windows of length T. The first query picks up the list of potential victim IPs (i.e., pvicIPs); that is, those dIPs that receive DNS replies from more than X unique source IP addresses. At the end of each time interval, the most current pvicIPs list refines the second query in the sense that it serves as input to the second query which samples traffic from these potential victim IPs at a higher rate (r1>r0) during the next time interval so as to confirm the presence of attack traffic using pre-specified threshold values.

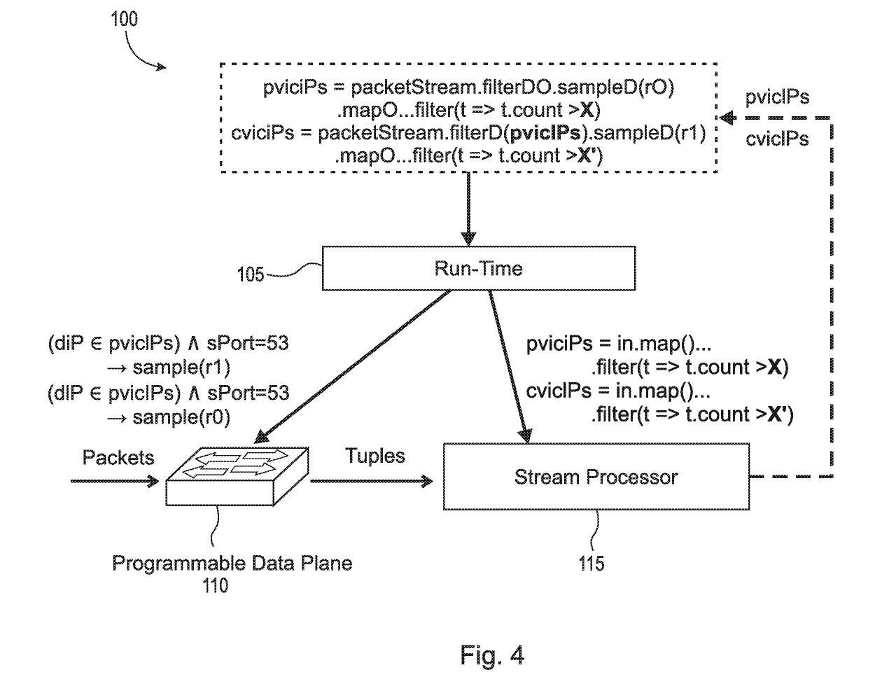

FIG. 4 is a schematic diagram illustrating a system 100 for performing streaming analytics, according to an example embodiment. FIG. 4 shows how query partitioning and iterative refinement can be realized in Sonata for this example. As shown in FIG. 4, this particular example iterative query refinement only updates the filtering and sampling configuration in the data plane; the particular example does not include updates to the stream processor. However, iterative queries are not limited to updating only the data plane's filtering and sampling configuration. For example, one can write iterative queries that process the packet stream differently—making confirmation more robust. The example above still may require maintaining per-IP counters, but it is possible to instead count at a coarser level of granularity and iteratively refine the queries that count at a finer level. When detecting DNS attacks at an IXP, a programmer might write a query that maintains per-MAC counters (i.e., counters on each of the IXP's physical ports), compares each of these values against some threshold, and populates pvicMACs, a list of MAC addresses suspected to receive attack traffic; although a large IXP may have millions of per-IP counters, even a large IXP would only have a few hundred counters for each MAC address. A query for the next interval can then use this query's output for the current interval to produce the pvicIPs list—processing packet tuples for victim MAC addresses only. Finally, over a subsequent time interval, another query can take the list of pvicIPs as input to confirm victim IPs, as shown above.

Example Evaluation

A trace-driven simulation was performed to evaluate the effectiveness of iterative query refinement and query partitioning. For this simulation, an example Sonata implementation was first used to express the queries for the DNS-based reflection attack monitoring application. Then a trace of IPFIX records was used, collected at a large IXP to measure how these two features help Sonata scale to high data rates. In this evaluation, is was shown that together Sonata's query partitioning and iterative refinement features reduce both the traffic rates that the stream processor sees and the total number of counters required for monitoring. Because the attack traffic is typically a small fraction of the total traffic, Sonata's iterative query refinement can dynamically and reactively filter non-attack traffic. The application also benefits from query partitioning, which performs certain filtering and sampling tasks in the data plane.

Experiment setup—A trace of IPFIX records was used, collected using a packet sampling rate of 1 in 10,000 from one of the largest IXPs in Europe. On average, this IXP handles about 3 Tbps of traffic, making it a good use case for the type of traffic rates Sonata is able to handle. A two-hour traffic trace collected from this IXP in August 2015 was used. This data set does not contain any user data or any personal information that identifies individual users. The data was collected between 2 and 4 a.m. (GMT+2) on a working day in August 2015. Since the collection took place during the non-peak hours, only observed 128 million flow records were observed in the data. To compare the traffic that Sonata returns for each query against ground truth, the portions of traffic that satisfy each Sonata query were manually identified.

To illustrate the benefits of each of Sonata's features, the system was evaluated using five different configurations: (1) No Filtering; (2) Simple Filtering: A filter that sends all DNS traffic to the stream processor, without sampling or query refinement; (3) No Refinement: Partitioning the query across the data plane and stream processor, without performing iterative refinement; (4) DP Refinement: Updating the query expressions dynamically to modify the data-plane configuration over two successive time intervals; and (5) DP & SP Refinement: Modifying both the data plane and the stream processor with iterative query refinement.

Reducing data rates—It was examined whether executing portions of a monitoring query in the programmable data plane reduces the resulting data rate at the stream processor. Table 1 shows the performance of the five modes in terms of the following metrics: (1) the median rate of packet tuples forwarded to the stream processor; (2) the median number of counters required to track the query at the stream processor; and (3) the median fraction of query-related packet tuples forwarded to the stream processor.

TABLE 1
Sonata's iterative query refinement and partitioning helps efficiently
capture traffic for the query.

| | Rate (kpps) | # Counters | % of Traffic |
|---|---|---|---|
| No Filtering | 210,794 | 2.08 B | 100% |
| Simple Filtering | 2,006 | 9.91M | 100% |
| Sonata | | | |
| No Refinement | 500 | 2.82M | 19% |
| DP Refinement | 500 | 1.68M | 88% |
| DP & SP Refinement | 500 | 200K | 95% |

Without filtering, the stream processor must process about 210 million packet tuples per second. Applying the filter to only consider DNS traffic reduces this rate to about two million tuples per second. Because Sonata's stream processor can be configured to accept a fixed maximum data rate, a fixed limit of 500,000 tuples per second was imposed, and it was explored how much of the traffic that satisfies the given query is captured by the different versions of query refinements. In the example simulation, the combination of different iterative refinement modes allowed Sonata to capture 95% of all traffic pertaining to the query, while reducing the overall data rate by a factor of about 400.

Reducing counters—Table 1 shows the median number of counters required for every ten-second time interval, for each of the five modes of the example application. Simple filtering reduced the number of counters required to detect attack traffic from about 2 billion counters to just under 10 million counters. Sonata's query partitioning reduced the number of counters further, to just under 3 million counters. Performing iterative refinement in the data plane reduced the number of counters to 1.68 million, and performing iterative refinement in both the data plane and at the stream processor (i.e., to refine the granularity of the query in real time) reduced the number of counters by more than a factor of ten compared to performing no query refinement at all. Additionally, query refinement enables the data plane to return a more accurate query stream, given a fixed rate of 500,000 tuples per second. Given this constraint, without iterative query refinement, the data plane returned only 19% of the tuples that satisfies the query to the stream processor; with iterative query refinement, 95% of the tuples that satisfy the original query were returned.

Extensions of the Disclosed Systems and Methods

In contrast to existing programmable data planes, which are relatively fixed-function (e.g., OpenFlow chipsets), emerging technologies, such as those that enable in-band network telemetry via P4, make it possible to redefine packet processing control-flow at compile time. This capability may enable a variety of richer measurement applications that can take advantage of a programmable, stateful network data plane.

One example of such an application is to use in-band network telemetry to attach latency statistics to packets as they travel through network devices, thus making it possible to pinpoint sources of increased latency, packet loss, or congestion. The network devices can affix additional data to packet headers (e.g., latency at each hop, the set of switches that the packet traversed) which can subsequently be used as input to a tuple-based query. Another such example is the use of so-called “active” machine learning algorithms that improve their accuracy over time by requesting more examples of labeled data. These algorithms can use iterative refinement to define a query that asks for more examples of attack payloads when the algorithm needs to improve its accuracy.

Streaming data—and the corresponding aggregate statistics that the queries produce—can drive real-time control decisions. For example, a programmable data plane that is driven by a Sonata controller can produce fine-grained measurements as an input to inference algorithms which can then drive the installation not only of forwarding table rules to refine the measurements, but also of forwarding table rules that affect how traffic is forwarded.

Another interesting aspect is concerned with how these systems can support approximate queries. Sonata and the examples presented above return tuple streams or statistics that are based on exact filter operations. In practice, however, many network monitoring queries may need not be so precise. An attack or performance degradation may be evident from a large deviation from baseline statistics under normal operation; in these cases, even an approximate result can reveal the existence of a problem.

Network operators must typically perform network management tasks while coping with fixed-function network monitoring capabilities, such as IPFIX and SNMP. The advent of programmable hardware makes it possible not only to customize packet formats and protocols, but also to install custom monitoring capabilities in network devices that output data in formats that are amenable to the emerging body of scalable, distributed stream processing systems.

In light of these trends, it is possible to think of network monitoring as a stream processing problem, where each packet is represented by a tuple, and streams of packets comprise tuple streams for which many distributed stream processing programming idioms can apply. Due to the inherently high rates of network traffic, realizing this programming abstraction requires reducing the traffic at the stream processor that does not satisfy the original query. The disclosed systems and methods show that (1) partitioning of function between the switch and the stream processor; and (2) the ability to iteratively refine both the data plane rules for a query and its corresponding stream processing pipeline can reduce data rates at the stream processor by multiple orders of magnitude by pushing many of the filtering operations into the data plane.

Digital Processing Environment

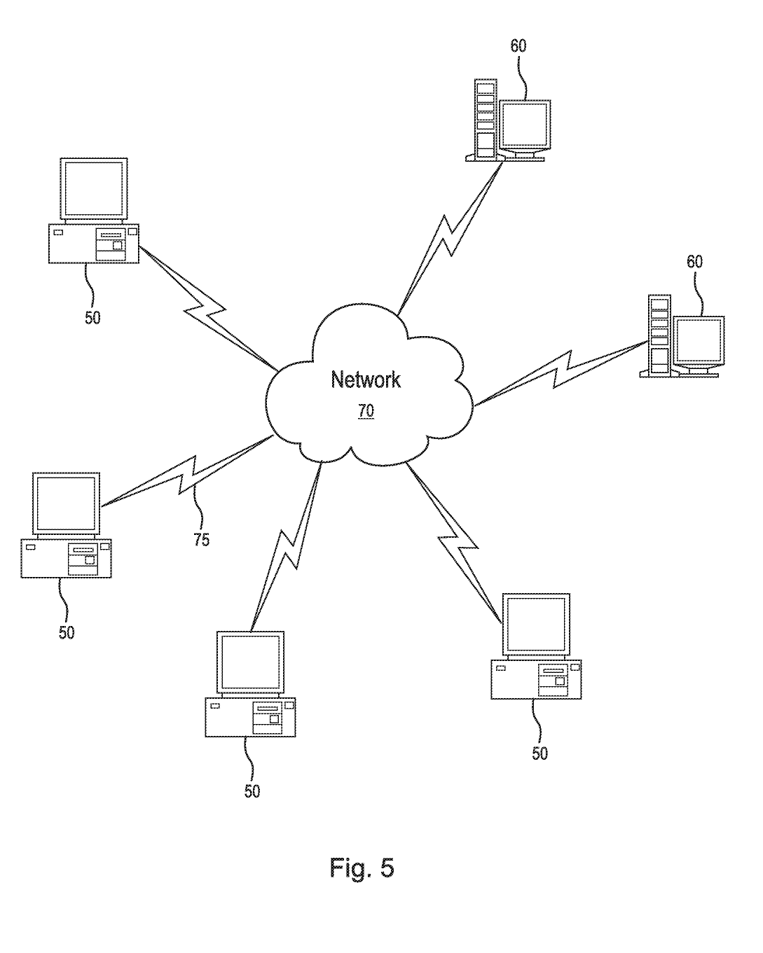

FIG. 5 illustrates a computer network or similar digital processing environment in which embodiments of the disclosed systems and methods may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60, via communication links 75 (e.g., wired or wireless network connections). The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

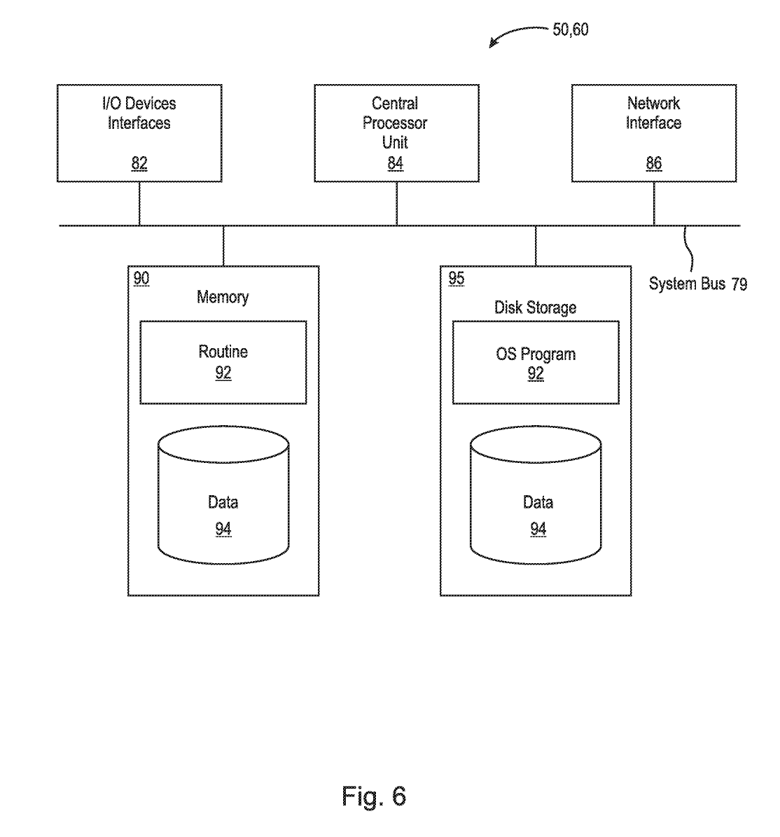

FIG. 6 is a diagram of an example internal structure of a computer (e.g., client processor/device 50 or server computers 60) in the computer system of FIG. 5. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 5). Memory 90 provides volatile storage for computer software instructions 92 and data 94 used to implement an embodiment of the present invention (e.g., processes 200 or 300 of FIGS. 2 and 3). Disk storage 95 provides non-volatile storage for computer software instructions 92 and data 94 used to implement an embodiment of the present invention. A central processor unit 84 is also attached to the system bus 79 and provides for the execution of computer instructions. The disk storage 95 or memory 90 can provide storage for a database. Embodiments of a database can include a SQL database, text file, or other organized collection of data.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection.

It should be understood that the example embodiments described herein may be implemented in many different ways. In some instances, the various methods, systems, and devices described herein may each be implemented by a physical, virtual, or hybrid general purpose computer. The computer systems 50, 60 may be transformed into machines that execute methods described herein, for example, by loading software instructions into either memory 90 or non-volatile storage 95 for execution by the CPU 84.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, or some combination thereof, and, thus, the data processors described herein are intended for purposes of illustration only and not as a limitation of the embodiments.

While example embodiments have been particularly shown and described, it will be understood by those skilled in the art that various changes in form and details may be made therein without departing from the scope of the embodiments encompassed by the appended claims.

What is claimed is:

1. A system for performing streaming analytics, the system comprising:
a runtime module;
a data plane component; and
a stream processor;
the runtime module configured to partition network monitoring queries between the data plane component and the stream processor.

2. A system as in claim 1 wherein the runtime module is further configured to iteratively refine the network monitoring queries based on output of the network monitoring queries.

3. A system as in claim 2 wherein the stream processor passes the output of the network monitoring queries to the runtime module for iterative refinement.

4. A system as in claim 1 further comprising a query engine configured to enable the network monitoring queries to be expressed as operations over a stream of tuples.

5. A system as in claim 1 wherein the data plane component is a switch.

6. A system as in claim 1 wherein the data plane component includes a fabric manager configured to receive high-level configurations from the runtime module and compile the high-level configurations into platform-specific device configurations.

7. A system as in claim 6 wherein the data plane component is configured to process incoming data packets based on the configurations received from the runtime module.

8. A system as in claim 1 wherein the stream processor includes a streaming manager configured to receive high-level configurations from the runtime module and compile the high-level configurations into platform-specific streaming data processing pipelines.

9. A system as in claim 8 wherein the stream processor is configured to receive data from the data plane component and execute a data processing pipeline over received packets processed as tuples based on the configurations received from the runtime module.

10. A system for performing streaming analytics, the system comprising:
a runtime module;
a data plane component; and
a stream processor;
the runtime module configured to iteratively refine network monitoring queries processed by at least one of the data plane component and the stream processor, the runtime module iteratively refining the network monitoring queries based on output of the network monitoring queries.

11. A method of performing streaming analytics, the method comprising:
partitioning network monitoring queries between components in a network; and
iteratively refining the network monitoring queries based on output of the network monitoring query.

12. A method as in claim 11 further comprising extracting only traffic pertaining to the network monitoring queries.

13. A method as in claim 11 further comprising enabling the network monitoring queries to be expressed as operations over a stream of tuples.

14. A method as in claim 11 wherein the components in a network include a data plane component and a stream processor component.

15. A method as in claim 14 wherein the data plane component is a switch.

16. A method as in claim 14 wherein the network monitoring queries specify whether a given operation is to be processed by the data plane component or by the stream processor component.

17. A method as in claim 14 wherein iteratively refining the network monitoring queries includes iteratively refining the network monitoring queries based on output of the network monitoring queries received from the stream processor component.

18. A machine readable storage medium having stored thereon a computer program for performing streaming analytics, the computer program comprising a routine of set instructions for causing the machine to:
partition network monitoring queries between components in a network; and
iteratively refine the network monitoring queries based on output of the network monitoring query.

19. A machine readable storage medium as in claim 18 further comprising instructions for causing the machine to enable the network monitoring queries to be expressed as operations over a stream of tuples.

20. A machine readable storage medium as in claim 18 wherein the components in a network include a data plane component and a stream processor component.

21. A machine readable storage medium as in claim 20 wherein the network monitoring queries specify whether a given operation is to be processed by the data plane component or by the stream processor component.

22. A machine readable storage medium as in claim 20 wherein the computer program includes instructions for causing the machine to iteratively refine the network monitoring queries based on output of the network monitoring queries received from the stream processor component.
